(19) United States
(12) Patent Application Publication
(10) Pub. No.: US 2013/0173340 A1
(43) Pub. Date: Jul. 4, 2013

(54) Product Offering Analytics

(71) Applicants: Derek P. Bagwell, Rochester, MN (US); Ivory W. Knipfer, Rochester, MN (US); William R. Taylor, Rochester, MN (US); Cheranellore Vasudevan, Bastrop, TX (US)

(72) Inventors: Derek P. Bagwell, Rochester, MN (US); Ivory W. Knipfer, Rochester, MN (US); William R. Taylor, Rochester, MN (US); Cheranellore Vasudevan, Bastrop, TX (US)

(73) Assignee: INTERNATIONAL BUSINESS MACHINES CORPORATION, Armonk, NY (US)

(21) Appl. No.: 13/342,246

(22) Filed: Jan. 3, 2012

(51) Int. Cl. G06Q 10/04

(52) U.S. Cl. 705/7.31

(57) ABSTRACT

Embodiments of the invention relate to supply chain recommendations in real-time. A filter model and a compliance model are provided to relate product proposal data with product order data, and to apply a measurement to the relationship in real-time. This applied measurement is a factor that is employed with respect to supply chain changes. Specifically, the measurement provides a measured correlation that is determinative of recommendations for changes to an associated supply chain.

### BACKGROUND

1. Technical Field

The present invention relates to a method and system for correlating data in a product supply chain. More specifically, the invention relates to a system and method that applies a correlation between an order proposal and a firm order within the product supply chain in real-time.

2. Description of the Prior Art

It is understood that many products are comprised of a combination of components that function as a whole to support the product. When configuring a product, it is important that the components of the product be compatible to support the product configuration and functionality. Product components are selected for various reasons, including pre-requisites, co-requisites, sales influence, etc. Accordingly, compatibility of the selected components is critical to support the final product.

### SUMMARY OF THE INVENTION

This invention comprises a method, system, and apparatus for supply chain analysis that provides real-time solutions to a supply chain based upon product proposal and product order data.

In one aspect of the invention, a system is provided with a processor in communication with memory and data storage. At least two databases are provided in communication with the data storage, including a first database and a second database. The first database is employed to store data pertaining to created order proposals, and the second database is employed to store data pertaining to firm orders. The created order proposals include data associated with time of submission and a specified product. The firm orders include an offer with consideration, including both orders received and time of receipt. A functional unit is provided in communication with the memory and includes both models and a manager to address supply chain correlation. More specifically, a filter model is provided to apply a correlation to data from both the first and second databases, and to capture related proposal and order data. A compliance model is provided in communication with output from the filter model. In real-time, the compliance model measures the applied correlation of the filter model to specified criteria. A decision manager is provided in communication with the compliance model, the decision manager functions to apply the measured correlation to changes in the supply chain.

In another aspect of the invention, a method is provided for organizing order proposals and firm orders, and applying a correlation to changes in an associated supply chain. Order proposal data is stored in a first database, with the order proposal data including a specified product and time of submission of the order. Firm order data is stored in a second database, with the firm order data including an offer with consideration, orders received and time of receipt. A correlation to data is applied from both the first and second databases, with the applied correlation including related proposal and order data. The applied correlation is measured against specified criteria in real-time, and the measured correlation is applied to supply chain changes.

In yet another aspect of the invention, a computer program product is provided with a computer readable storage medium having embodied computer readable program code. More specifically, the code is configured to organize order proposals and firm orders. A first database of created order proposal data is stored in data storage. The first database includes time of submission and a specified product, and more specifically the order proposal is an offer for consideration. The second database includes data pertaining to a firm order, including an offer with consideration, orders received and time of receipt. Computer readable program code is provided to apply a correlation to data from both the first and second databases. This code includes capturing related proposal and order data. Computer readable program code is provided to measure the application correlation to specified criteria in real-time. Finally, computer readable program code is provided to apply the measured correlation to changes in an associated supply chain.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 depicts a flow chart illustrating a process for analyzing proposal data with respect to a trending flow of product backlog.

FIG. 2 depicts a block diagram illustrating an example of filter models.

FIG. 3 depicts a block diagram illustrating examples of compliance models

FIG. 4 depicts a block diagram illustrating a chart for replacement models.

FIG. 5 depicts a block diagram illustrating tools embedded in a computer system to support deriving correlations between the data sets and applying a measurement associated with the correlation to changes in the product supply chain.

FIG. 6 depicts a flow chart illustrating a process for loading the log from storage and parsing the continuous log for one or more select threads.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional unit described in this specification has been labeled with tools, models, and/or managers. The functional unit may be implemented in programmable hardware devices such as field programmable gate arrays, programmable array logic, programmable logic devices, or the like. The functional unit may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of an identified functional unit need not be physically located together, but may comprise disparate instructions stored in different locations which, when joined logically together, comprise the functional unit and achieve the stated purpose of the functional unit.

Indeed, a functional unit of executable code could be a single instruction, or many instructions, and may even be distributed over several different code segments, among different applications, and across several memory devices. Similarly, operational data may be identified and illustrated herein within the functional unit, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of modules, managers, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

In the following description of the embodiments, reference is made to the accompanying drawings that form a part hereof, and which shows by way of illustration the specific embodiment in which the invention may be practiced. It is to be understood that other embodiments may be utilized because structural changes may be made without departing form the scope of the present invention.

Sales and marketing of products is a dynamic function that brings a product to market. One challenge associated with product sales is product inventory and the cost of maintaining the inventory. There are various factors that contribute to product inventory, and the goal is to address one or more of these factors. Correlating proposal data to real order and historical shipments provides insight into trends and patterns. More specifically, comparison of product configuration proposals with order backlog data in real-time provides insight together with supply chain actions to reduce inventory. Such actions include, but are not limited to, price changes, supply adjustments, product reductions, withdrawals, etc. Accordingly, a real-time solution that addresses order backlog functions to align the supply of the product with the demand for the product.

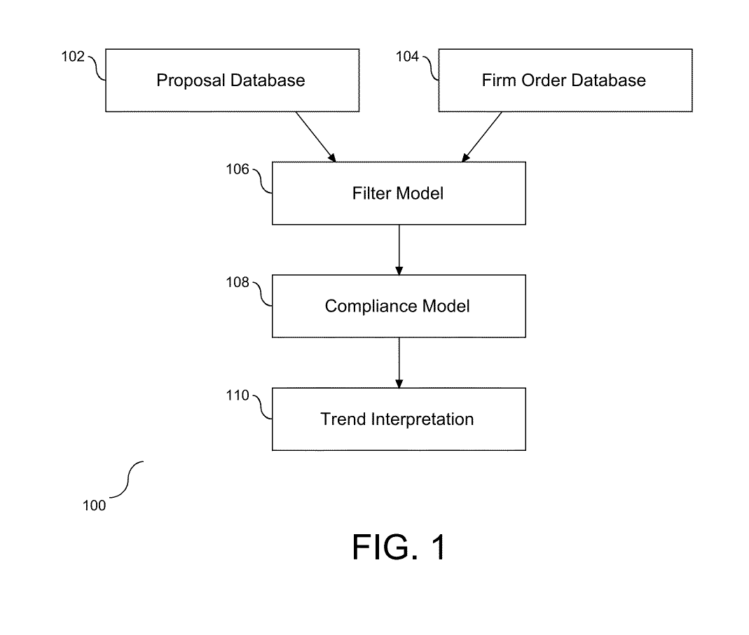

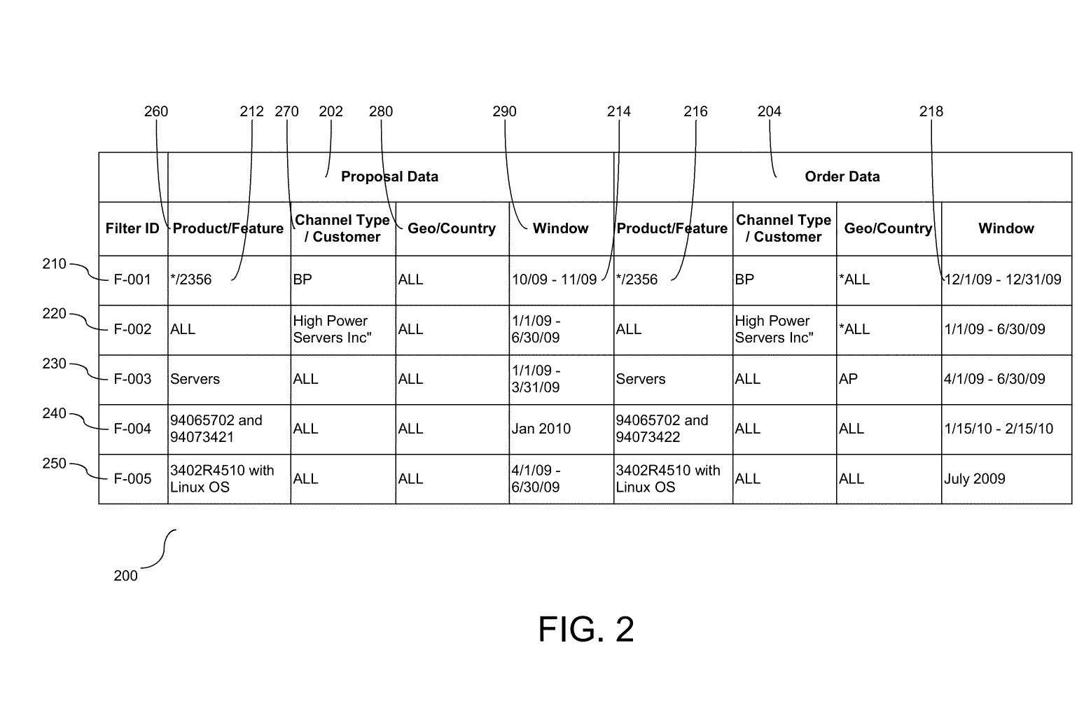

FIG. 1 is a flow chart (100) illustrating a process for analyzing proposal data with respect to a trending flow of product backlog. There are two data elements that feed into the functionality demonstrated in the flow chart, including a database of proposal data (102) and a database of firm orders (104). The proposal database (102) organizes and stores data pertaining to all proposals created, including the time when the proposals were submitted and product content. The firm order database (104) organizes and stores data pertaining to firm orders received from customers, including all orders received and the time when the orders were received. Data from both of the first and second databases (102) and (104), respectively, are received as input by a filter model (106) which functions to trim data in the databases to pertinent data selected for consideration. More specifically, the filter model (106) parses the proposal data according to product and time, and parses the firm order data according to order characteristics. Details of the filter models are shown in FIG. 2 and described below in detail. Accordingly, the filter models function to prune data present in both the proposal and firm order databases.

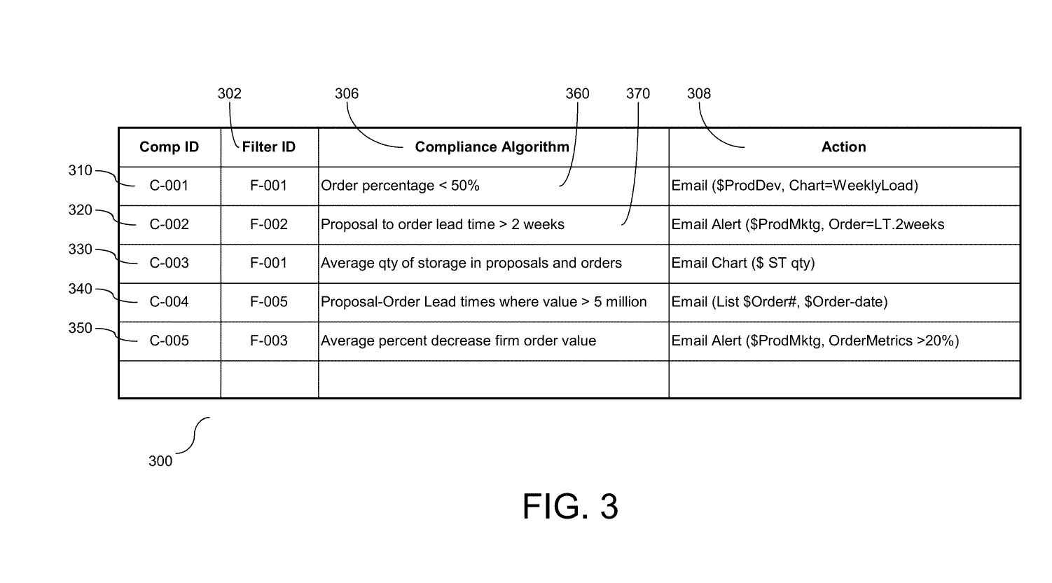

The pruned data emanating from step (106) is subjected to a compliance model (108), which measures trends as they emerge from a proposal. Details of the compliance model are shown in FIG. 3 and described below in detail. The trends as identified by the compliance model are subject to interpretation (110) so that the trends may be appropriately acted upon. More specifically, the identified trends enable a measured correlation provided by the compliance model to be applied to supply chain changes. Accordingly, the filter and compliance models communicate with the first and second databases to dynamically enable changes in the product supply chain.

As shown in FIG. 1, a filter model is applied to the proposal database (102). FIG. 2 is a block diagram (200) illustrating an example of filter models. As shown, there are five examples of filters (210), (220), (230), (240), and (250), each of which may be applied to the proposal data (202) and order data (204). Each of the filters pertains to a unique product or feature identifier (260), a channel of trade or customer (270), a geographical region (280), and a time window (290). With respect to the example filter models, the first filter (210) parses proposal data (202) by a filter code (212) and a specific time window (214), and at the same time the first filter (210) parses order data (204) by the same filter code (214) and an identified time window (216). More specifically, the first filter is parsing the databases to mine data with respect to proposals and orders under a specific feature code that became actual orders within a specific time window. A filter model may be selected from a grouping of pre-defined model, or in one embodiment, the user can define a filter model with select definitions therein. Accordingly, the invention should not be limited to the filter models described herein.

As shown in FIG. 2, there are other examples of filter models. For example, the second filter model (220) mines data with respect to proposals and orders placed by a customer designated by a specific name during a specified time window. The third filter model (230) mines data with respect to proposals for all servers during a specified time periods and respective orders for all servers during a specified time period. The fourth filter (240) mines data with respect to proposals associated with specific product numbers in a specific time period that became orders during a specific time period. In this example, the second product was replaced with a new product as shown by the change in one digit of the product identifier. The fifth filter (250) mines data with respect to proposals associated with a specific product number and operating system and a specific time frame that became orders during a second specific time frame. The filter model shown in FIG. 2 is a tool to specify a set of data that should be considered for analysis. The data generated by the filter model combines two sets of data, one set coming from an order backlog repository and a second set coming from a proposal repository. Accordingly, as shown herein, each filter is applied to the two databases to parse through data that fits specified criteria to generate a subset of data.

FIG. 3 is a block diagram (300) illustrating examples of compliance models. The compliance model functions to interpret the subset of data generated by the filter model(s). More specifically, the compliance models apply a compliance algorithm to the subset of generated data in real-time to look for trends as they emerge from the proposal data. The trends are then employed to predict data orders. A compliance model may be selected from a grouping of pre-defined model, or in one embodiment, the user can define a compliance model with select definitions therein. Accordingly, the invention should not be limited to the compliance models described herein.

As shown, there are five compliance models (310), (320), (330), (340), and (350). Each compliance model has an identifier (302) and an associated compliance algorithm (306). In addition, each compliance model utilizes a filter identifier from the filtering models (304), and an action to be employed (308) following application of the compliance model. For example, the first compliance application (360) checks whether a percentage of orders among proposals associated with the first filter model is less than fifty percent. If the algorithm is valid, an electronic mail message is utilized to send the pertinent information to a designated set of recipients. The second compliance application (370) checks whether an average lead time from proposal to order associated with the second filter is more than two weeks. If the algorithm is valid, an electronic mail message is utilized to send the pertinent information to a designated set of recipients. Accordingly, each compliance model is applied in real-time to dynamically look for trends as such trends emerge.

The compliance model is a tool to identify compliance with specified criteria. The compliance algorithms utilized by the compliance model associate a relationship between a proposal dataset and an order dataset. More specifically, each compliance algorithm has an identifier, parses data associated with a filter identifier, and utilizes a compliance algorithm to determine an action to be executed. In one embodiment, the compliance algorithm is a set of criteria for a specified business objective. The action to be executed specifies what needs to take place if the results of the compliance algorithm matches or falls within the specified parameters.

The data represented in the first database (102) may be organized in various structures. In one embodiment, the data is organized in a hierarchical manner referred to herein as a first nested structure. With respect to product data comprised of multiple components, also known as composite products, each of the components may be represented in different tiers in the hierarchy. A root noted of a first nested structure of the hierarchy may represent a multi-component product, and each leaf node may represent a product component. Similarly, the proposal data of the second database (104) may also be organized in a hierarchical manner, referred to herein as a second nested structure. A root node of the second nested structure of the hierarchy may represent a multi-component product order, and each leaf node may represent a product order component.

A correlation between product data and proposal data takes place through a hierarchical structural comparison of the first and second nested structures, and specifically the nodes of the first structure are compared with the nodes of the second structure. In one embodiment, the correlation takes place in real-time. By comparing the two nested structure, proposal data is compared to real order backlog data. Resulting correlations from the comparison can be used to make a change in the supply chain or recommendation for a change to the supply chain. Similarly, the correlations can be used to identify product pricing problems, component compatibility problems, as well as identifying the source of the order, and the source of any incompatibility. In one embodiment, the comparison provides correlation data to identify trends and patterns associated with the product(s). For example, the correlation data may pertain to historical product purchases and shipments so as to assess adoption rates in view of order configurations. Accordingly, the real-time correlation and associated correlation data functions to affect changes to a product supply chain in real-time.

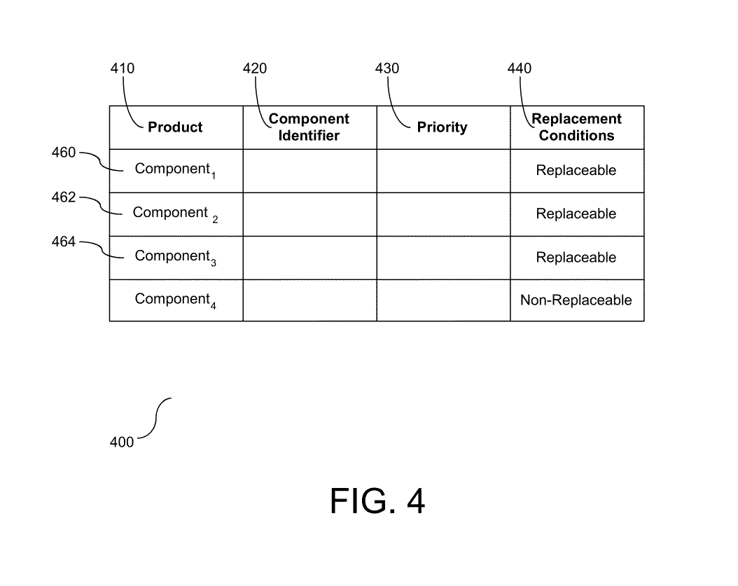

As shown in FIGS. 1-3, replacement components are identified, together with one or more replacement of components and associated replacement conditions. FIG. 4 is a block diagram (400) illustrating a chart for replacement of one or more defined components. The chart is one embodiment for illustrating replacement of components, and the invention should not be limited to this embodiment. As shown, there are four columns, with a first column (410) representing a product, a second column (420) representing a component identifier, a third column (430) representing a priority for replacement of the product, and a fourth column (440) representing conditions for replacement. More specifically, the chart shows which parts are replaceable and in which order replacement should be attempted. The priority, as referenced in the second column (420), may be based upon different factors, including aspects of importance and optional parts. Based upon the example shown herein, only three components (460), (462), and (464) are identified as replaceable. In one embodiment, the priority may be controlled by dynamic conditions of the current system configuration. As shown in this example, there is a designation in the priority column for a part that is not replaceable. Accordingly, the chart shown herein is a tool to organize information pertaining to replacement components.

In a multiple component system, some or all of the components may be replaced with a replacement part. As shown in FIGS. 1-4, product data is compared with order proposal data in order to derive a relevant correlation between the data sets. Such correlations can be used to make changes to a product supply chain. Accordingly, a derived historical relationship between the data sets may contribute to a projection of future product sales based on current product proposals.

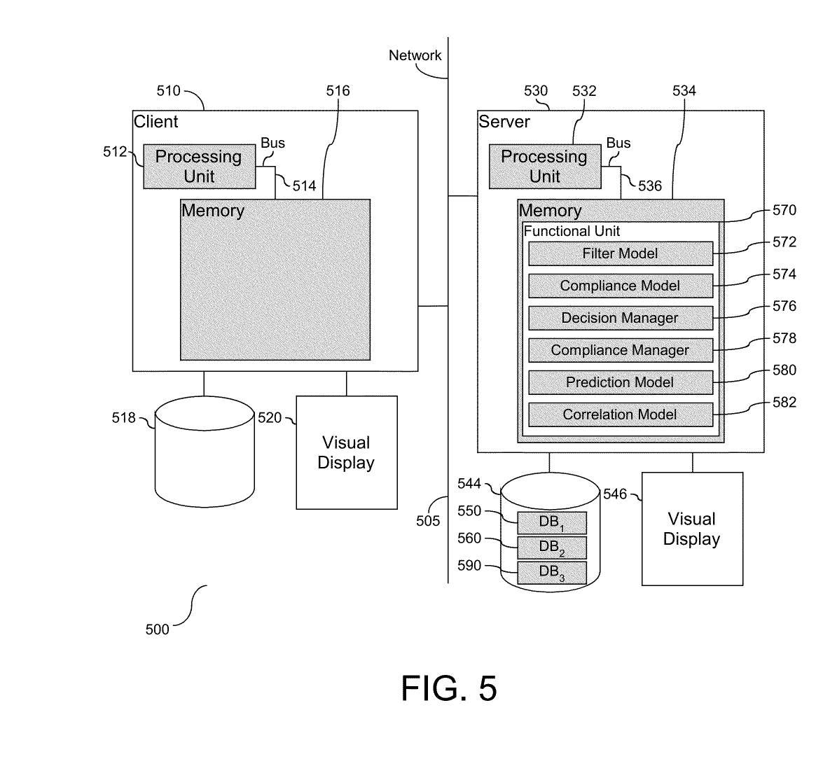

FIG. 5 is a block diagram (500) illustrating tools embedded in a computer system to support deriving correlations between the data sets and applying a measurement associated with the correlation to changes in the product supply chain. For illustrative purposes, a computer system is provided with a client machine (510) in communication with a server (530) across a network (505). The client machine (510) is provided with a processing unit (512) in communication with memory (516) across a bus (514). In one embodiment, client machine (510) is in communication with local data storage (518) and a visual display (520).

The client machine (510) is shown in communication with the server (530) across the network (505). In one embodiment, the server (530) is provided with a processing unit (532) in communication with memory (534) across a bus (536). As shown herein, the server (530) is in communication with at least one storage device (544) and a visual display (546). In one embodiment, the server (530) may be in communication with additional storage devices, and/or additional data centers. The storage device (544) is configured to support at least two databases, including a first database (550) and a second database (560). The first database (550) includes data pertaining to created order proposals, which includes time of submission of the order proposal, and the product associated with the order. In one embodiment, the order proposal is an offer for consideration. The second database (560) includes data pertaining to one or more firm orders, which includes but is not limited to, an offer with consideration attached, as well as orders received and time of receipt of each of the orders.

A functional unit (570) is provided in communication with memory (534); the functional unit (570) supports tools to assess relevant correlations that affect supply chain changes. As shown, the functional unit (570) is provided with a filter model (572), a compliance model (574), a decision manager (576), a compliance manager (578), and a prediction model (580). The filter model (572) functions to apply a correlation to data from both the first database (550) and the second database (560), and specifically to capture related proposal and order data. In one embodiment, the filter model (572) generates a subset of data as input into a correlation model (582), with the input based on an attribute such as a time period, type of order, and geography. In one embodiment, the filter model (572) applies the correlation between a proposal and a corresponding purchase order. Similarly, in one embodiment, the filter model (572) has a dependency between order proposal and firm orders.

The compliance model (574) functions to leverage output from the filter model (572). More specifically, the compliance model (574) functions to measure the correlation between the filter model (572) and specific criteria in real-time. In one embodiment, the prediction model (580) is provided in communication with the compliance model (574) and functions to correlate an order proposal with an order backlog in the second database (560). The decision manager (576) functions with the compliance model (574) and applies the correlation measured by the compliance model (574) to changes in the supply chain. Accordingly, filter model (572), compliance model (574), and decision manager (576) function together to affect real-time changes to the supply chain.

A third database (590) is provided in communication with the storage device (544), and is referred to herein as a proposal database. The proposal database (590) functions to tracks sets of proposed order configurations. As these order configurations are in a proposed state, one or more of the proposed order configurations may be formally submitted as an order.

In one embodiment, the order proposal data of the first database (550) is organized in a first logical product configuration in the form of a first hierarchical structure, such as a nested structure. The first hierarchical structure includes a first root node representing a product and each leaf node representing a product component. Similarly, the firm order data of the second database (560) is organized in a second logical configuration in the form of a second hierarchical structure, such as a second nested structure. The second hierarchical structure includes a second root node representing a product order and each leaf node representing a product order component. In one embodiment, the component includes time of occurrence, geography, or customer. The compliance manager (578) of the functional unit (570) communicates with the first and second hierarchical structures of the first and second databases (550) and (560), respectively, to perform a real-time hierarchical structural correlation of the first and second hierarchical structures. The functionality of the compliance manager (578) includes a comparison of at least one node of the first hierarchical structure with at least one node of the second hierarchical structure. Accordingly, the nested configuration of the hierarchical structures supports real-time correlation of data between the first and second databases.

The models and managers function as tools within a unit to support real-time aspects of supply chain changes, including supply change recommendations. As identified above, the filter model (572), compliance model (574), decision manager (576), compliance manager (578), and prediction model (580), hereinafter referred to as tools, function as elements to support supply chain changes and/or supply chain recommendations. The tools (572)-(580) are shown residing in memory (534) local to the server (530). However, the tools (572)-(580) may reside as hardware tools external to memory (534), or they may be implemented as a combination of hardware and software. Similarly, in one embodiment, the tools (572)-(580) may be combined into a single functional item that incorporates the functionality of the separate items. As shown herein, each of the tools (572)-(580) are shown local to the server (530). However, in one embodiment they may be collectively or individually distributed across a network or among multiple machines and function as a unit to evaluate hardware performance. Accordingly, the tools may be implemented as software tools, hardware tools, or a combination of software and hardware tools.

As will be appreciated by one skilled in the art, aspects of the present invention may be embodied as a system, method or computer program product. Accordingly, aspects of the present invention may take the form of an entirely hardware based embodiment, an entirely software based embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

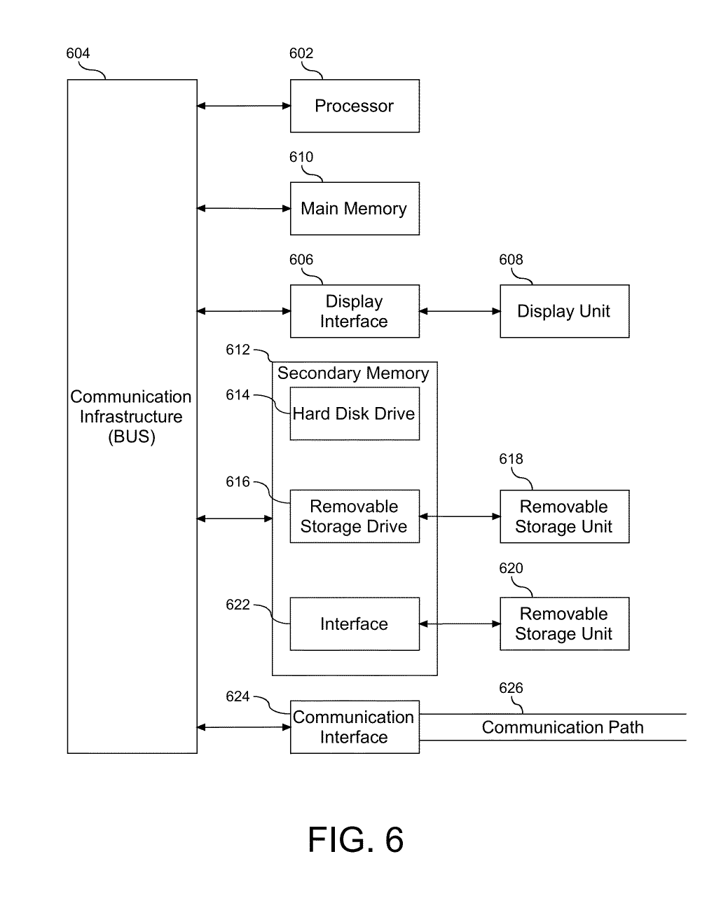

Referring now to the block diagram of FIG. 6, additional details are now described with respect to implementing an embodiment of the present invention. The computer system includes one or more processors, such as a processor (602). The processor (602) is connected to a communication infrastructure (604) (e.g., a communications bus, cross-over bar, or network).

The computer system can include a display interface (606) that forwards graphics, text, and other data from the communication infrastructure (604) (or from a frame buffer not shown) for display on a display unit (608). The computer system also includes a main memory (610), preferably random access memory (RAM), and may also include a secondary memory (612). The secondary memory (612) may include, for example, a hard disk drive (614) and/or a removable storage drive (616), representing, for example, a floppy disk drive, a magnetic tape drive, or an optical disk drive. The removable storage drive (616) reads from and/or writes to a removable storage unit (618) in a manner well known to those having ordinary skill in the art. Removable storage unit (618) represents, for example, a floppy disk, a compact disc, a magnetic tape, or an optical disk, etc., which is read by and written to by removable storage drive (616). As will be appreciated, the removable storage unit (618) includes a computer readable medium having stored therein computer software and/or data.

In alternative embodiments, the secondary memory (612) may include other similar means for allowing computer programs or other instructions to be loaded into the computer system. Such means may include, for example, a removable storage unit (620) and an interface (622). Examples of such means may include a program package and package interface (such as that found in video game devices), a removable memory chip (such as an EPROM, or PROM) and associated socket, and other removable storage units (620) and interfaces (622) which allow software and data to be transferred from the removable storage unit (620) to the computer system.

The computer system may also include a communications interface (624). Communications interface (624) allows software and data to be transferred between the computer system and external devices. Examples of communications interface (624) may include a modem, a network interface (such as an Ethernet card), a communications port, or a PCMCIA slot and card, etc. Software and data transferred via communications interface (624) are in the form of signals which may be, for example, electronic, electromagnetic, optical, or other signals capable of being received by communications interface (624). These signals are provided to communications interface (624) via a communications path (i.e., channel) (626). This communications path (626) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (610) and secondary memory (612), removable storage drive (616), and a hard disk installed in hard disk drive (614).

Computer programs (also called computer control logic) are stored in main memory (610) and/or secondary memory (612). Computer programs may also be received via a communication interface (624). Such computer programs, when run, enable the computer system to perform the features of the present invention as discussed herein. In particular, the computer programs, when run, enable the processor (602) to perform the features of the computer system. Accordingly, such computer programs represent controllers of the computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed.

Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### Alternative Embodiment

It will be appreciated that, although specific embodiments of the invention have been described herein for purposes of illustration, various modifications may be made without departing from the spirit and scope of the invention. More specifically, the details herein pertain to hierarchical representations of product components and product orders. In one embodiment, the product components and/or the product orders may have a different representation or configuration while continuing to support real-time aspects of supply chain changes, including supply change recommendations. Accordingly, the scope of protection of this invention is limited only by the following claims and their equivalents.

1. A system comprising:
a processor in communication with memory and data storage;
the data storage having:
a first database of created order proposals, including time of submission and product specified, wherein an order proposal is an offer for consideration; and
a second data base of firm orders, wherein a firm order includes an offer with consideration attached, including orders received and time of receipt;
a functional unit in communication with the memory, the functional unit comprising:
a filter model to apply a correlation to data from both the first and second databases to capture related proposal and order data;
a compliance model in communication with output from the filter model, the compliance model to measure the applied correlation to specified criteria in real-time; and
a decision manager in communication with the compliance model, the decision manager to apply the measured correlation to supply chain changes.

2. The system of claim 1, further comprising a proposal database in communication with the data storage, the proposal database to track sets of proposed order configurations, wherein one or more of the proposed order configurations may be formally submitted as an order.

3. The system of claim 1, further comprising the filter model to generate a subset of data as input to a correlation model based on an attribute selected from the group consisting of: time period, type of orders, and geography.

4. The system of claim 1, further comprising the filter model having a dependency between the order proposals and the firm orders.

5. The system of claim 1, further comprising the order proposal data organized in a first logical product configuration as a nested structure, with a first root node of the first structure representing a product, and each leaf node representing a product component, and further comprising the firm order data organized in a second logical configuration as a second nested structure, with a second root node of the second structure representing a product order, and each leaf node representing a product order component, the component selected from the group consisting of: time of occurrence, geography, and customer.

6. The system of claim 4, further comprising a compliance manager to perform a hierarchical structural correlation of the first and second nested structures in real-time, the correlation including a comparison one or more nodes in the first nested structure with one or more nodes in the second nested structure.

7. The system of claim 1, further comprising the filter model to apply the correlation between a proposal and a corresponding purchase order.

8. The system of claim 1, further comprising a prediction model in communication with the compliance model, the prediction model to correlate an order proposal with an order backlog in the second database.

9. (canceled)

10. (canceled)

11. (canceled)

12. (canceled)

13. (canceled)

14. (canceled)

15. (canceled)

16. (canceled)

17. (canceled)

18. A computer program product comprising a computer readable storage medium having computer readable program code embodied therewith, the computer readable program code comprising:
computer readable program code configured to organize order proposals and firms orders, including:
a first database of created order proposal stored in data storage, the first database including time of submission and product specified, wherein an order proposal is an offer for consideration; and
a second database of form orders, wherein a firm order includes an offer with consideration attached, including orders received and time of receipt;
computer readable program code configured to apply a correlation to data from both the first and second databases, including capturing related proposal and order data; computer readable program code configured to measure the applied correlation to specified criteria in real-time; and
computer readable program code configured to apply the measured correlation to supply chain changes.

19. The computer program product of claim 18, further comprising computer readable program code configured to track sets of proposed order configurations, wherein one or more of the proposed order configurations may be formally submitted as an order.

20. The computer program product of claim 18, further comprising computer readable program code configured to generate a subset of data as input to a correlation model for applying the correlation, the input including an attribute selected from the group consisting of: a time period, types of orders, and geography.

21. The computer program product of claim 18, further comprising computer readable program code configured to organize the order proposal data in a first logical product configuration as a first nested structure, with a first node of the first structure representing a product, and each leaf node representing a product component, and further comprising computer readable program code configured to organize the firm order data in a second logical configuration as a second nested structure, with a second root node of the second structure representing a product order and each leaf node representing a product order component.

22. The computer program product of claim 21, further comprising computer readable program code configured to perform a correlation between the first and second nested structures in real-time, the correlation including a comparison of one or more nodes of the first structure with one or more nodes of the second structure.

23. The computer program product of claim 22, further comprising computer readable program code configured to apply the correlation between a proposal and a corresponding purchase order.

24. The computer program product of claim 18, further comprising computer readable program code configured to correlate an order proposal with an order backlog reflected in the second database.
